(19) United States
(12) Patent Application Publication
(10) Pub. No.: US 2004/0150234 A1
(43) Pub. Date: Aug. 5, 2004

(54) Ocean swell energy converter

(76) Inventors: Bradley J. Snedden, Somerset, OH (US); Andrew L. Snedden, Somerset, OH (US); Clark A. Tibbs, Newark, OH (US)

Correspondence Address: Thomas A. O'Rourke, Bodner & O'Rourke, LLP, 425 Broadhollow Road, Melville, NY, 11747, US

(21) Appl. No.: 10/192,741

(22) Filed: Jul. 10, 2002

Related U.S. Application Data
(60) Provisional application No. 60/304,368, filed on Jul. 10, 2001.

(51) Int. Cl. H02P 9/04; F03B 13/10; F03B 13/12

(52) U.S. Cl. 290/53

(57) ABSTRACT

An apparatus for converting the energy in the motion of the rise and fall of ocean swells into electrical is disclosed. The device includes a cable having a first end and a second end with a bladder connected to the first end of the cable. The bladder moves generally in a vertical direction as an ocean swell rises and falls. There is a means for changing the direction of travel of a portion of the cable so that as one portion of the cable rises and falls with an ocean swell a second portion of the cable provides back and forth motion that is translated to rotational movement to rotate an armature on a generator.

The present invention is a conversion of U.S. Provisional Application Serial No. 60/304,368, filed Sep. 10, 2001 the disclosures of which are incorporated by reference.

Over the years there have been numerous instances where there have been shortages of energy resources. Whether it is a shortage of petroleum due to political turmoil in foreign lands, a lack of production due to insufficient raw materials or lack of refinery capacity, these shortages are troublesome for the average consumer causing inconvenience and increased cost. Recently, there have also been shortages in electrical production as well. While there are sufficient quantities of certain sources of power such as coal and nuclear energy, fewer electrical generating stations have been built in recent years due to political, environmental and other important reasons. Unfortunately, energy demand continues to escalate.

As a result of increasing energy needs, there has been renewed interest in the use of renewable resources of energy to overcome the shortages that occur from time to time. These renewable energy sources typically are environmentally friendly, and, as a result, tend to be viewed favorably in the political arena. As a result, there have been a number of initiatives to develop solar power, wind power, and water power. One major problem with these renewable sources of energy is the infrastructure cost. Although the sun, wind and the tides are readily available in many locations, the cost or transferring, for example, the solar energy to electrical energy is typically significantly greater than the cost of refining a similar amount of coal or oil. One reason why solar energy is so high is the cost of the solar cell. These silicon or germanium wafers are expensive to manufacture. Solar energy, while appropriate in many locations is not always available due to weather conditions. During cloudy periods, the electrical energy generated falls off significantly. As a result, solar energy is of primary interest in those parts of the world where there are significant numbers of sunny days.

Wind power while also attractive does have drawbacks as well. Windmills are expensive to build and many parts of the country do not have the strong, regular winds that are necessary to make this energy source dependable. There have also been attempts to harness tidal energy. One of the drawbacks to the use of tidal and related energy from the ocean has been the cost. Salt water is extremely corrosive and as a result, the equipment necessary to generate the power is expensive or has a limited useful life. In addition, many of the devices used in producing energy from waves or tidal flows employ complex turbines and blades. In addition, many of these devices are damaging to sensitive ecosystems.

Over the years, there have been a number of patents that have been issued relating to the generation of electrical energy from tidal action and wave motion. These patents include U.S. Pat. Nos. 4,228,360, 3,965,365, 4,355,511 and 4,627,240. None of the designs in these patents translate the ocean swell energy into potential energy before translating it into torque that produces electrical current from a generator. In U.S. Pat. No. 4,228,360 the presence of the extra cable wrapped around the shaft to make up for tidal changes potentially causes problems. Cable has a tendency not to re-wrap the same way. As a result, the cable will have a tendency tear its self apart from cross wear. The next problematic issue in this design is the quick torque motion that the cable will have pulling on the shaft by means of a spiral spring device. This is inefficient, especially with a limited amount of travel. If the swell, rises one foot the spiral spring will reduce the motion put on the torque shaft by almost half. This design translates the energy of the ocean swells directly into torque on the shaft.

The device of U.S. Pat. No. 4,627,240 includes one or more vertical supports fixed to the bottom of the body of water. This arrangement is therefore very expensive to implement. This device also has a definite height above sea level. This restriction prevents optimum energy conversion, because if the swells are very high, the device may go up to its maximum height, while the maximum height of the swell is greater. This device also presents a barrier to the horizontal force produced by the swells. Though the device only moves vertically, it is situated parallel to the shoreline. Thus, the swells, along with moving the float vertically, will present a horizontal force that may decrease the device's output.

This device places the generator on its frame, which is in the ocean, or body of water. Though the generator may be covered and protected from water, the placement of it is a potential electromechanical hazard. Also, repair and maintenance of the device will be difficult and time-consuming, especially in harsh weather conditions or increased swell height.

### OBJECTS OF THE INVENTION

It is an object of the present invention to provide a system and apparatus for generating electrical power from the rising and falling of swells on a body of water.

It is an object of the present invention to generate electrical power from the swells on a body of water by means of an apparatus that is relatively mechanically uncomplicated and inexpensive to set up.

It is an object of the present invention to provide an apparatus for generating electrical power that is economical to run and does not require extensive upkeep and maintenance.

It is an object of the present invention to provide an apparatus for generating electrical power from swells on a body of water using gravity.

It is an object of the present invention to provide an apparatus to generate electrical power from ocean swells that is environmentally safe.

### SUMMARY OF THE INVENTION

The present invention harnesses an initial force of a swell by using buoyancy that translates into a force that is used to generate electrical power. In this invention the swell is used to turn a flywheel and to generate torque on the armature of a generator. The downward motion of the weight due to gravity turns a flywheel to produce power. In the present invention, an air filled bladder which may be in the form of a conventional sealed drum is buoyant and floats on a body of water. An anchor member is positioned in the water and has an underwater means, such as a pulley system, for the bladder to be raised and lowered as the swells pass by. In one embodiment there is a cable that the bladder rides on. As the body of water rises and falls on the swells generated by the tides, wind, etc., the bladder rises and falls. Attached to the bladder is a cable or line that may pass from the bladder around a pulley attached to an anchor and ultimately across the water to a gravity means on the shore. The gravity means is typically a structure that has at least one support which suspends a pulley system in the air. The pulley system is preferably a helical pulley system. In one embodiment the main cable runs over the pulley and the vertical motion of the bladder causes the cable to wind about a shaft causing it to rotate The motion of the shaft can be used to turn an armature on an electrical generator.

In an alternative embodiment the cable is attached to a weight. The weight is raised and lowered by the main cable in response to the vertical motion of the bladder. The motion of the bladder rotates the main shaft, which in turn, can rotate a flywheel. The flywheel can be provided with a sprocket that mates with a chain which turns in response to the rotation of the flywheel. The chain on the sprocket is connected to an armature on a generator which converts the mechanical energy into electrical.

In another embodiment, the bladder is connected to a first cable and the weight is connected to a second cable. When the weight is raised to a point, the falling of the swell causes the weight to drop. The dropping of the weight spins the flywheel, which will keep the sprocket, belt or other means in continuous rotation. The flywheel contains a clutch bearing which keeps the flywheel moving in a single direction. The continuous rotation of the flywheel and sprocket ensures that the generator will be transforming mechanical energy into electrical energy at all phases of the ocean swell cycle.

### BRIEF DESCRIPTION OF THE DRAWINGS

FIG. 1 is a side view of the system of the present invention.

FIG. 2 is a view of the arrangement of the flywheel, clutch and cables on the shaft.

FIG. 3 is a side view of the underwater pulley system, showing the main cable-bladder interactions and the anchor to the ocean floor.

FIG. 4 is a side view of the main shaft attachment apparatus.

FIG. 5 is a side view of the helical pulley system on shore, in a singular pulley system.

FIG. 6 is a front view of the helical pulley system, in a multiple pulley system.

FIG. 7 is a side view of the interaction between the main shaft pulleys, the free-floating gear reduction system, the weight mechanism, and the generator.

FIG. 8 is a front view of a second embodiment of the helical pulley system in a multiple pulley system.

### DETAILED DESCRIPTION OF THE INVENTION

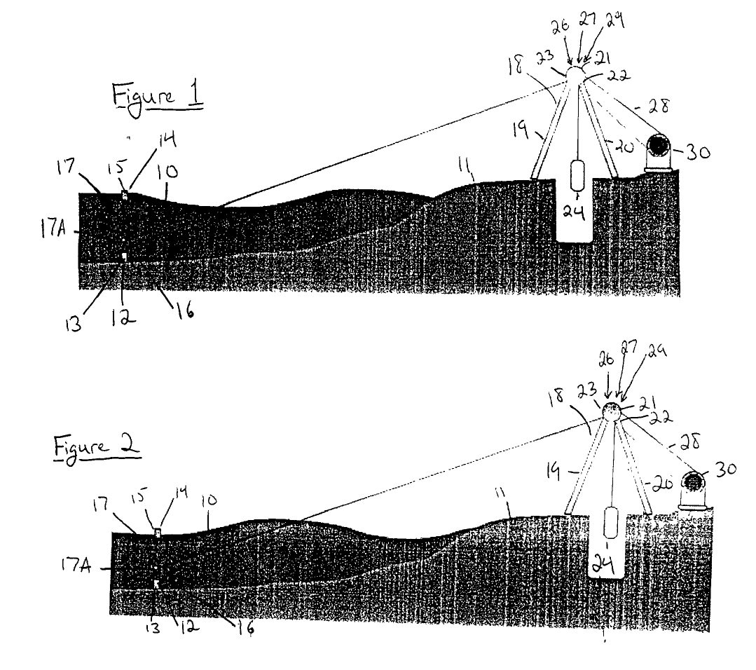

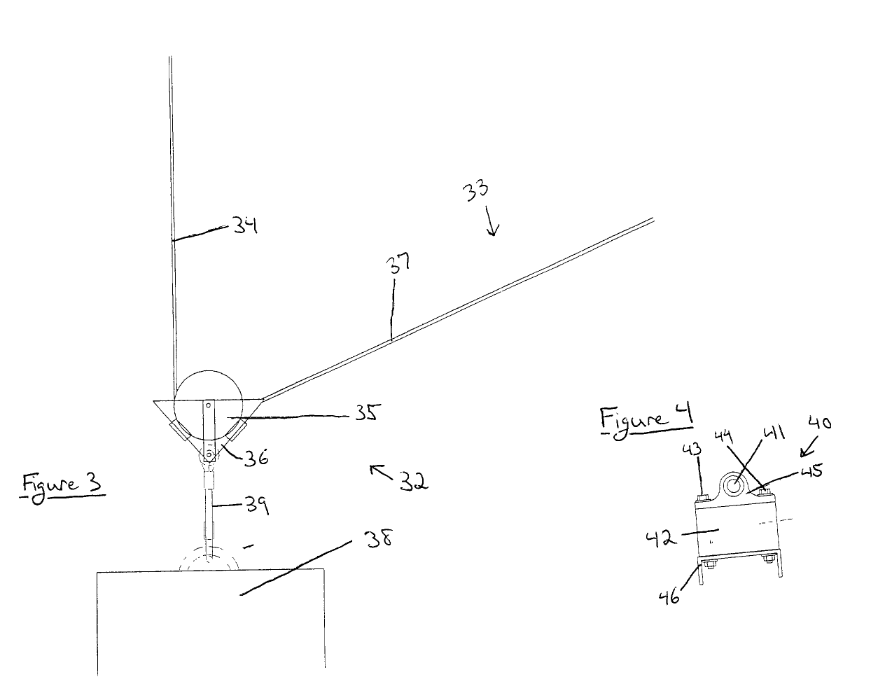

As seen in FIG. 1 there is a body of water 10 that is adjacent to a shoreline 11. The body 10 may be any suitable body of water that has swells caused by the wind, currents, tides etc. Swells are defined as any periodic up and down movement of the water. Positioned in the water is an anchor member 12 which holds one end of a cable 17 in position so that the bladder 15 or a floating member on the other end of the cable can rise and fall with the swells. Alternatively, a rod, pole or other means can extend from the anchor 12 or the ground to a position preferably above the upper surface of the water. The rod pole or other means provides a location for the bladder 15 to ride in a generally vertical manner. This pole can be a vertical member having a first end generally in the area of the bottom of the water and a second end generally above the area of the surface of the water. A bladder 15 travels generally upwardly and downwardly in response to swell motion. The bladder 15 can be any floating means such as a buoy, foam containing member, wood or a related object. The upward and downward motion causes the cable 17 to rise and fall. The cable 17 extends from the bladder 15 down toward the anchor 12 where it passes under a shaft or pulley 17A and extends to shore. Any appropriate means for changing the direction of the cable can be used. The cable 17 can be made of any appropriate material such as a coated metal, a non ferrous metal, plastic, rope, etc. The cable can be sheathed for protection from abrasion or corrosion by a hollow tube as well. As an alternative to the pulley or shaft, the cable 17 can pass through a curved hollow tube. The bladder 15 may be made of any suitable buoyant material including but not limited to an empty drum. The pulley or shaft may be tethered to the anchor member 12 by a cable, chain or other suitable means that will provide the pulley or shaft with a means for the bladder 15 to rise and fall with the swells. The cable 17 extends shoreward from the shaft or pulley to a support member 18.

As seen in FIG. 1 the support member 18 may be in the form of a first A-frame member 19 and a second A-frame member 20. The two A-frame members are joined together by a shaft 21 that extends from near the apex 22 of one A-frame member to the other. The cable 17 attached to the bladder 15 may be wrapped around the shaft 21. Alternatively, the end of the line opposite the bladder 15 is attached to a weight 24 that rises and falls in response to the motion of the bladder 15 and can turn the shaft 21. The motion of the bladder 15 rotates a flywheel (not shown) on the shaft 21. The flywheel may have a sprocket that mates with a chain 28 that turns in response to the rotation of the flywheel. Alternatively, a belt or other means can be used to turn the shaft 21. A clutch bearing keeps the flywheel turning in the same direction whether the weight is rising or falling. The rotation of the fly wheel causes the sprocket to turn the chain which is connected to the armature of generator 30. The generator 30 converts the mechanical energy into electrical energy.

The legs 19 and 20 of the A-frame members are preferably anchored in the ground by for example, concrete or other material that will prevent the legs from moving unnecessarily in response to the operation of the device.

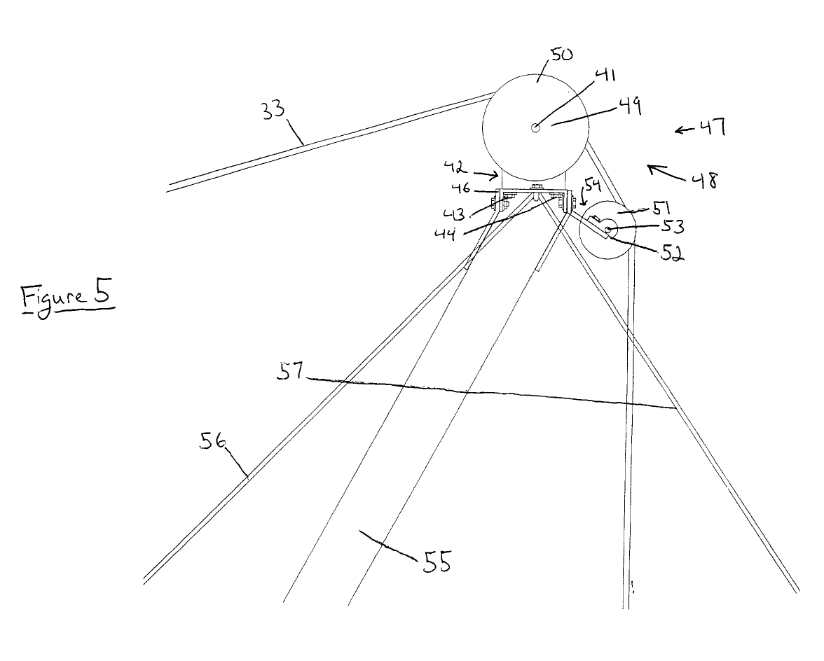

FIG. 3 shows the underwater pulley system 32 which converts the up and down movement of the main cable 33 to a seaward and shoreward movement. The main cable 33 is attached to the bladder or buoy at a first end 34. The cable goes around a shaft 35 or in a preferred embodiment a pulley. Pulley guides 36 align the main cable 33 with the pulley 35 and prevents the cable from being derailed off the pulley. A second end 37 of the main cable 33 is routed under the shaft or pulley 35 to the energy conversion means. The energy conversion means 47 can include a helical pulley system for conversion of ocean swell energy to electrical energy. The energy conversion means 47 is typically on the shore but could also be in the water or on a platform. The underwater pulley system 32 is maintained in a fixed position underwater by anchor weight 38. The underwater pulley system 32 should be as close to the anchor weight 38 as possible to allow for maximum movement of the bladder 15. The main cable 33 is preferably in constant tension due to the buoyancy of the bladder 15. The pulley 35 may be connected to the anchor weight 38 by a cable, rod or chain or other means 39. The entire underwater pulley system 32 should be made of a non-corrosive material if the device is going to be in a salt water environment. In a preferred embodiment the bladder is restricted from any lateral or forward-back movement. For example, if the bladder moves into a position not directly vertical above the underwater pulley system, there is a risk that the main cable may come off the pulley. Alternatively, friction will be created when the main cable runs into the edges of the pulley. This friction can result in wear of the main cable. Accordingly, the bladder should be permitted to only travel in a generally vertical direction.

Located at the apex of the A-frame is the main shaft attachment apparatus 40 that maintains the position of the main shaft 41, as seen in FIG. 4. The main shaft 41 is used to transfer torque produced by bladder movement, or winding and unwinding of the cable, into additional torque resources. The main shaft 41 is secured to the bearing mount extension 42 by one bearing mount bolt 43 and a second bearing mount bolt 44. The bearing mount bolts 43 and 44, in addition, secure the main shaft bearing mount 45 to the main “c” beam support 46. The main shaft bearing mount 45 is used to support the main shaft 41 while providing it with the ability to spin freely in a fixed position. The main shaft bearing mount 45 may be replaced by any means that will support the main shaft while allowing it to spin freely, such as an eye hook or U-shaped support.

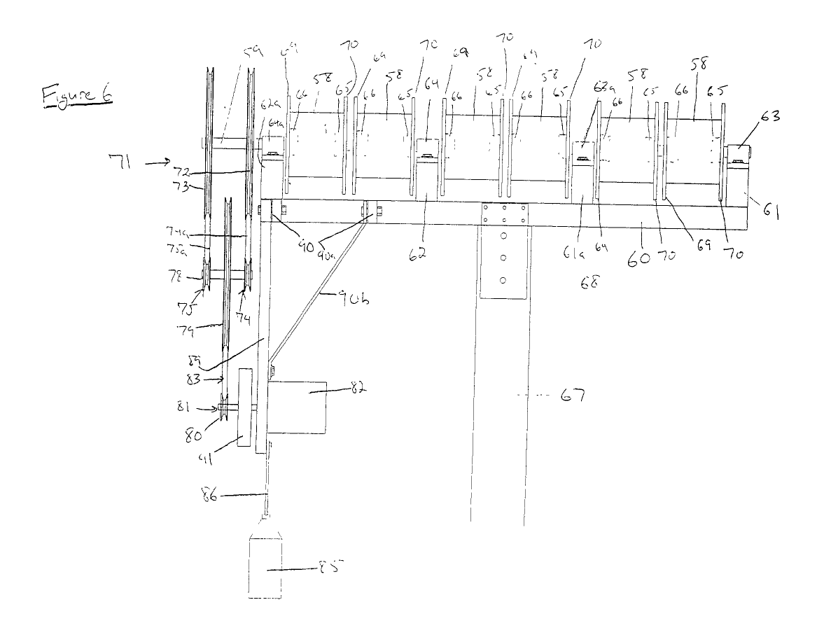

FIG. 5 is an example of a singular cable system for the generation of electricity. In this embodiment the main cable 33 extends from the underwater pulley system to an energy conversion means 47 on shore. The energy conversion means 47 need not be on shore. It may be in the water as long as the main torque assembly 48 is above the surface of the water or fully encased in a protective casing. The main cable 33 preferably runs over a single helical pulley 49 and is attached to a weight (not shown). The helical pulley 49 may be replaced by any pulley or shaft that will allow the main cable 33 to rise and lower the weight without friction on the main shaft 41. In this assembly, there is the main cable 33 and the helical pulley 36, which transfers the cable movement into torque on the main shaft 41. The main torque assembly 48 is supported by the main “c” beam support 46, bearing mount extension 42, and main shaft bearing mounts 45 together. Helical pulley plastic guide 50 is used to prevent the cable from being derailed which could occur, for example, in extreme weather conditions. The main cable 33 also turns over a cable guide pulley 51. Cable guide pulley 51 is used to prevent side-to-side sway of the weight produced by lateral movement of the main cable on the helical pulley 49. Cable guide pulley mounting system 52 mounts the cable guide pulley 51 utilizing a first bearing 53 and second bearing 54. Bearings 53 and 54 allow for free rotation of the cable guide pulley 51 in connection with the vertical movement of the weight.

The entire ocean swell energy-producing device is suspended and supported in the air by main support 55. The main support should provide stability in the most adverse conditions. Thus, the main support is preferably in the form of two generally vertical members and a horizontal member extending from one vertical member to the other at some point above the base of the members. In a preferred embodiment there are two A-frames connected at their apex by the horizontal member which may be the main shaft. Another support possibility is a pair of box frames connected by the main shaft in the middle of the highest edge, or perhaps, at the corner of the top edge and edge closest to the shore or other suitable support.

If a single support or other support frame is used or otherwise, the apparatus may also be supported by a first support cable 56 and a second support cable 57. The support cables 56 and 57 may also be guy lines. Preferably the support cables 56 and 57 are anchored to the ground and the device in order to reduce twisting and perpendicular movement of the ocean swell energy-producing device.

In the singular system, a generator can be placed on the ground near the device or attached to the shaft 41. Any suitable means, such as gears and belts may be used to turn the armature of the generator in conjunction with the rotation of the main shaft 41.

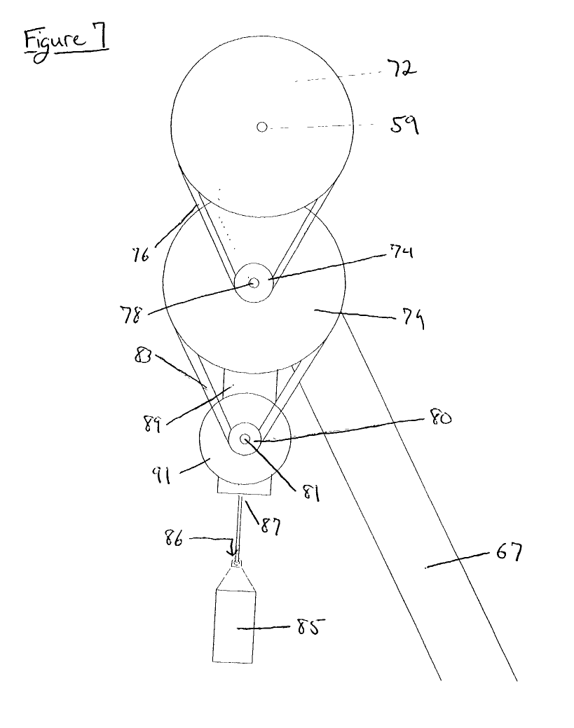

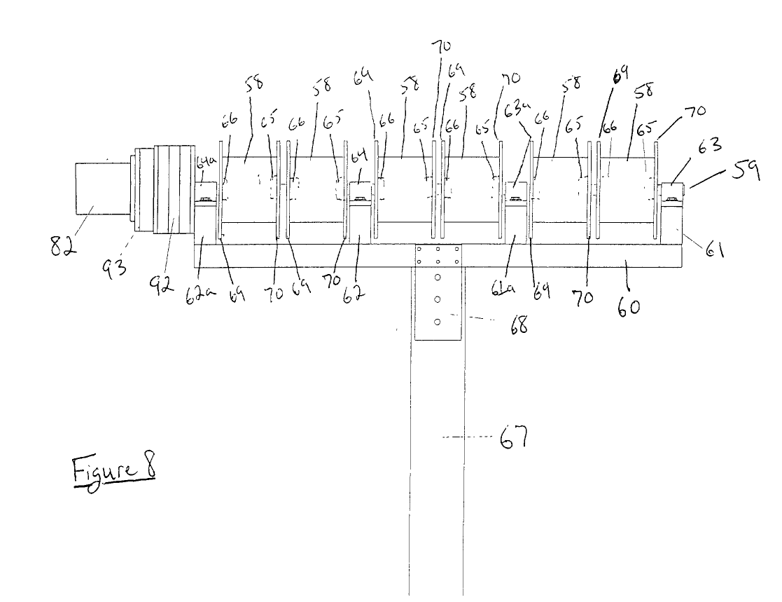

FIG. 6 is an example of a multiple cable system for generating electricity. The system includes the use of multiple pulleys preferably helical. The helical pulley will allow the cable attached to it to wind and unwind in an efficient, generally frictionless manner. Each pulley 58 is attached to a cable and bladder. These may be any number of pulleys and of any type. The combination of multiple helical pulleys will be an increased torque on the mail shaft 59. In this embodiment, the plurality of helical pulleys 58 are mounted atop a “c” beam support 60. The “c” beam support 60 has bearing mount extensions 61, 61A, 62 and 62A. The bearing mount extensions 61, 61A, 62 and 62A raise and support the main shaft bearing mounts 63, 63A, 64 and 64A. The main shaft bearing mounts 63, 63A, 64 and 64A support the main shaft 59 while allowing it to spin freely. The main shaft bearing mounts and bearing mount extensions may be located any where on the “c” beam support 60. The main “c” beam support 60 is immovably connected to a main support 67 by a main support brace 68. The main support 67 may be a single beam or an A-frame may be at both ends of the main shaft 59.

Each helical pulley 58 contains two bearings: a clutch bearing 65 and a regular bearing 66. The clutch bearing 65 is used to transfer torque from the helical pulley 58 into a uni-directional torque on the main shaft 59. The clutch bearing 65 allows the helical pulleys 58 to have an accumulated effect on the main shaft 59. The regular bearing 66 can be any number of bearing types, such as, ball or liquid, that allow the helical pulleys 58 to spin freely and with as little friction as possible. Also, each helical pulley 58 has a first helical pulley plastic guide 69 and a second helical pulley plastic guide 70, which prevent the cable from being derailed.

The combined torque of the multiple helical pulleys 59 is transferred to the gear reduction system 71. The gear reduction system 71 may be at either end of the main shaft 59. A first main shaft pulley 72 is immovably connected to the main shaft 59. A second main shaft pulley 73 is immovably connected to the main shaft 59 as well. The use of multiple main shaft pulleys will translate the torque from the main shaft into a different torque ratio. The main shaft pulleys 72 and 73 are connected to input pulleys 74 and 75 by belts 74A and 75A. The input pulleys 74 and 75 are immovably connected to an input shaft 78. An output pulley 79 is also immovably connected to the input shaft 78, preferably between input pulleys 74 and 75. The output pulley 79 is preferably larger in diameter then the input pulleys 74 and 75. The output pulley 79 is connected to an input pulley 80 on the armature 81 of a generator 82 by a belt 83. Also on the armature 81 of the generator 82 is a flywheel 91. The flywheel 91 prevents slowing of the rotation of the armature 81 when the main shaft 59 goes from winding to unwinding the cables.

All of the pulleys in the gear reduction system may be replaced by shafts, gears or pulleys of any type that will allow for free rotation and transferring torque to the armature of a generator. One or more of the belts in the gear reduction system may be replaced by cables or chains that will stay in constant tension and allow for free rotation of the pulleys. The gear reduction system may be free floating or can be immovably anchored to the ground. For example, support members may be attached to the input shaft 78 which would allow for free rotation but only in a fixed position.

Attached to a second portion 83A of the armature of generator 82 may be a helical pulley 84. As an ocean swell rises, cable is unwound from the helical pulleys 58, causing the main shaft 59 to rotate. The torque on the main shaft 59 is translated through the gear reduction system 71. As the swell rises, the second portion 83A of the armature on the generator 82 rotates. A weight 85 may be attached to cable 86, preferably at an end thereof. The other cable end 87 is attached to a helical pulley 84. When the ocean swell falls the weight 85 drops, rotating the armature of the generator 82. If the second portion 83A of the armature of the generator 82 is a shaft, then the helical pulley 84 preferably needs a clutch bearing 88. If the there are two independent armatures for the generator, then a clutch bearing is not likely to be needed.

The purpose of a weight 85 that is raised and lowered by the swells is to provide constant motion on the armature 81 of the generator 82. Thus, in addition to the turning of the flywheel 91 by the bladder as the swells go up and down, the weight provides motion to the flywheel or the generator as well. In another embodiment, a spring loaded main shaft could be used and the weight eliminated. A spring-loaded shaft would ensure that the main cable is in constant tension, and thus, would continually be creating torque on the main shaft during all phases of the ocean swells.

Alternatively, a weight 85 may be used as a stabilizing force which will prevent the gear reduction system 71 from moving in response to rotation of the main shaft 59. The weight 85 may be attached to the generator mounting arm 89 by a cable 86.

The second portion 83 of the armature 81 is held in place by a generator mounting arm 89. The other end of the generator mounting arm is rotatably connected to the main “c” beam support 60 by swivel brackets 90 and 90A. The swivel brackets 90 and 90A may be replaced by an immovable bracket or a fixed attachment means. A support member 90B provides the generator mounting arm 89 with additional support by attaching to swivel bracket 90A.

A flywheel 91 may be used on the armature 81. The flywheel 91 will reduce the difference between the winding and unwinding motion of the main shaft 59 on the armature 81 of the generator 82. Thus, the armature 81 will preferably be continuously rotating with the rise and fall of the ocean swells.

As seen in FIG. 8, the gear reduction system may be replaced by a planetary gear system 92. The planetary gear system 92 may be placed at either end of the main shaft 59. Attache to the planetary gear system is a flywheel (not shown) which is encased in a flywheel housing 93. Again, the flywheel will keep the armature 81 of the generator 82 continuously in motion whether the main shaft 59 is winding or unwinding. The generator may be suspended in the air and attached to the helical pulley system or it may be on the ground and connected to the main shaft 59 by any suitable means, such as gears and belts.

We claim:

1. An apparatus to convert the energy in ocean swells into electrical energy comprising:
a) a cable having a first end and a second end;
b) a bladder connected to the first end of the cable, said bladder being adapted to move generally in a vertical direction as an ocean swell rises and falls;
c) a means for changing the direction of travel of a portion of the cable so that as one portion of the cable rises and falls with an ocean swell a second portion of the cable provides rotational movement to rotate an armature on a generator.

2) The apparatus according to claim 1 wherein the means for changing the direction of travel is a shaft.

3) The apparatus according to claim 1 wherein the means for changing the direction of travel is a rotating shaft.

4) The apparatus according to claim 1 wherein the means for changing the direction of travel is a pulley.

4) The apparatus according to claim 3 wherein the pulley is anchored to the ocean floor.

5) The apparatus according to claim 1 wherein the second portion of the cable rotates a flywheel.

6) The apparatus according to claim 5 wherein the second portion of the cable moves in a first direction due to the rising of an ocean swell and rotates a flywheel in one direction and said cable moves in a second direction as an ocean swell falls and rotates the flywheel in the same direction.

7. An apparatus for converting the energy in ocean swells into electrical energy comprising:
at least one cable, said cable extending from a floating bladder around an underwater pulley system to an energy conversion means;
said energy conversion means comprising a main torque assembly which transfers the cable movement into torque on a main shaft
said main torque assembly being supported by a main beam support, a bearing mount extension, and one or more main shaft bearing mounts.

8. The apparatus according to claim 7 wherein said main torque assembly includes a helical pulley.

9. The apparatus according to claim 8 wherein a helical pulley plastic guide is used to prevent the cable from being derailed.

10. The apparatus according to claim 8 wherein said main cable also turns a cable guide pulley said cable guide pulley preventing side-to-side sway of a weight produced by lateral movement of the main cable on a helical pulley.

11. The apparatus according to claim 10 wherein a cable guide pulley mounting system mounts the cable guide pulley utilizing a first bearing and second bearing said bearings allowing for free rotation of the cable guide pulley in connection with the vertical movement of the weight.

12. The apparatus according to claim 7 wherein there is a helical pulley under the surface of the water, said pulley being connected to an anchor, said anchor embedded in the ocean floor.

13. The apparatus according to claim 12 further comprising a flywheel and wherein when said swell has an upward motion said bladder rises and rotates said flywheel in a first direction and when said swell has a downward motion the falling bladder rotates the flywheel in the same direction.

14. The apparatus according to claim 13 wherein said flywheel is on the main shaft and has a sprocket attached to said flywheel.

15. The apparatus according to claim 14 wherein a chain around the sprocket is attached to a generator and the rotation of the sprocket causes the chain to rotate an armature on a generator.

16. The apparatus according to claim 13 wherein there is a clutch bearing to allow for unidirectional rotation of said flywheel.

17. A method for converting the energy in ocean swells into electrical energy comprising:
a) providing a bladder attached to a cable having a first end and a second end;
b) moving the bladder generally vertically as an ocean swell passes the bladder
c) translating the vertical movement of the bladder to rotational movement as the bladder rises and falls;
d) using the rotational movement to rotate an armature on a generator.
